(19) United States
(12) Patent Application Publication
(10) Pub. No.: US 2023/0364458 A1
(43) Pub. Date: Nov. 16, 2023

(54) METHODS AND SYSTEMS FOR CONTROLLING DELIVERY OF FIRE SUPRESSANT

(71) Applicant: Carrier Corporation, Palm Beach Gardens, FL (US)

(72) Inventors: Weina Li, Acton, MA (US); Richard L. Lupien, Grafton, MA (US); Thomas Carl Kjellman, Uxbridge, MA (US)

(21) Appl. No.: 18/301,234

(22) Filed: Apr. 16, 2023

Related U.S. Application Data
(60) Provisional application No. 63/364,532, filed on May 11, 2022.

(51) Int. Cl. A62C 37/11; A62C 35/68

(52) U.S. Cl. CPC A62C 37/11; A62C 35/68

(57) ABSTRACT

Methods and operations for controlling effective delivery of fire suppressant are disclosed. The fire suppression system comprises a control valve operatively coupled with a cylinder containing a fire suppressant. The system comprises a controller operatively coupled with the control valve. The controller is configured to command the control valve to open, discharging a flow of the fire suppressant at a first flow rate; and adjust the flow of the fire suppressant to a second flow rate during the discharge.

### CROSS REFERENCE TO A RELATED APPLICATION

The application claims the benefit of U.S. Provisional Application No. 63/364,532 filed May 11, 2022, the contents of which are hereby incorporated in their entirety.

### BACKGROUND

The invention relates generally to fire suppression systems, and, more specifically, to delivery control of fire suppressant in a fire suppression system.

Current fire suppression systems use a fixed delivery system whereby the agent is released from the cylinder(s) at a rate that is based on the fill and pressure decay of the unit. Generally, upon opening of the cylinder valve, the agent flows at a full open rate until exhausted. This may not be the optimum agent application method.

### BRIEF DESCRIPTION

Aspects of the disclosure relate to methods, apparatuses, and/or systems for controlling delivery of fire suppressant.

In some embodiments, a fire suppression system is disclosed. The fire suppression system comprises a control valve operatively coupled with a cylinder containing a fire suppressant. The system comprises a controller operatively coupled with the control valve. The controller is configured to command the control valve to open, discharging a flow of the fire suppressant at a first flow rate; and adjust the flow of the fire suppressant to a second flow rate during the discharge.

In some embodiments, wherein the second flow rate is lower than the first flow rate.

In some embodiments, the fire suppression system further comprises one or more sensors configured to generate output signals conveying information related to fire conditions; and the controller is configured to: determine one or more control parameters based on the output signals; and adjust the first flow rate based on the one or more control parameters.

In some embodiments, the controller is configured to adjust the first flow rate based on one or more of the control parameters reaching a parameter threshold.

In some embodiments, the controller is configured to adjust the second flow rate to a subsequent flow rate.

In some embodiments, the subsequent flow rate is lower than the second flow rate.

In some embodiments, the subsequent flow rate is higher than the second flow rate.

In some embodiments, the second flow rate is different than a flow rate resulting from a decay in pressure in the fire suppressant source.

In some embodiments, a method for controlling operations of a fire suppression system comprising a control valve, a fire suppressant source, and a controller. The method comprises discharging a flow of the fire suppressant at a first flow rate; and adjusting the flow of the fire suppressant to a second flow rate during the discharge.

In some embodiments, a fire suppression system is provided. The system comprises a control valve operatively coupled with a cylinder containing a fire suppressant; and a controller operatively coupled with the control valve, wherein the controller is configured to command the control valve to open and close discharging the fire suppressant intermittently, the control valve being commanded to: discharge a flow of the fire suppressant at a first flow rate; stop the discharge; and discharge a second flow of the fire suppressant at a second flow rate.

In some embodiments, the control valve is commanded to discharge the fire suppressant at the first flow rate for a first discharge period of time; and stop the discharge for a first shut-off period of time.

In some embodiments, the controller is configured to determine the first discharge and/or the first shut off period of time.

In some embodiments, the control valve is configured to stop the discharge after a second discharge period of the second flow.

In some embodiments, the system comprises one or more sensors configured to generate output signals conveying information related to fire conditions. The controller is configured to: determine one or more control parameters based on the output signals; and determine the first discharge and/or the first shut off period of time based on the control parameters.

In some embodiments, the controller is configured to determine the first flow rate based on the determined control parameters.

In some embodiments, the controller is configured to determine the second flow rate based on the determined control parameters reaching a parameter threshold.

Various other aspects, features, and advantages of the invention will be apparent through the detailed description of the invention and the drawings attached hereto. It is also to be understood that both the foregoing general description and the following detailed description are examples and not restrictive of the scope of the invention.

### BRIEF DESCRIPTION OF THE DRAWINGS

FIG. 1 is a schematic illustration of an exemplary fire suppression system, in accordance with one or more embodiments.

FIG. 2 shows an exemplary operation of a fire suppression system, in accordance with one or more embodiments.

FIG. 3 shows another exemplary operation of a fire suppression system, in accordance with one or more embodiments.

FIG. 4 shows a flow diagram of an exemplary method for controlling operations of a fire suppression system, in accordance with one or more embodiments.

FIG. 5 shows a flow diagram of an exemplary method for controlling operations of a fire suppression system, in accordance with one or more embodiments.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

Generally, fire suppression systems are configured to discharge a suppression agent (e.g., in response to detecting flames/fire). Traditionally, the agent is discharged from a cylinder at a high initial flow rate, where the flow rate decreases gradually during discharge in response to a decay in pressure in the cylinder (i.e., at a constant rate, without actively controlling or reducing the amount of agent being discharged). In operation (in an example applied to fire conditions in cooking appliance with hot oil), the suppression agent reacts with cooking oil to form a saponification layer (e.g., a foam layer) which prevents (or at least mitigates) the oil from reigniting. Once the foam dissipates, if the oil is cool enough, it may not have the ability to reignite. However, in some cases, delivering the agent at a continuous fast rate may result in overflowing of the agent off of the foam layer without reaching the hot oil. Therefore, the effective agent reacting with oil is much less than what is delivered. As described below, by optimizing the delivery of suppression agent it is possible to increase the amount of effective agent reaching the oil, thereby improving the fire suppression performance.

The present disclosure, in accordance with some embodiments, describes a system 100 configured for controlling delivery of fire suppressant. In some embodiments, system 100 may be configured to adjust (e.g., increase, decrease, start, and/or stop) the flow of the suppression agent during the discharge. For example, in some embodiments, system 100 may be configured to discharge the agent at a first rate initially (e.g., to allow the agent to form a saponification layer) and discharge the agent at different rates subsequently. In some embodiments, the adjustment of the discharge flow rate may be determined based on one or more control parameters. In some embodiments, the control parameters may include one or more of fire conditions parameters, time, fire suppressant parameters, fire suppressant system parameters, environmental parameters, and/or other control parameters. Accordingly, the control methods of the present disclosure may provide an effective way to suppress the fire conditions because it may allow for using less agent, avoid spillover and/or waste of suppression agent, and may allow for use of smaller cylinders.

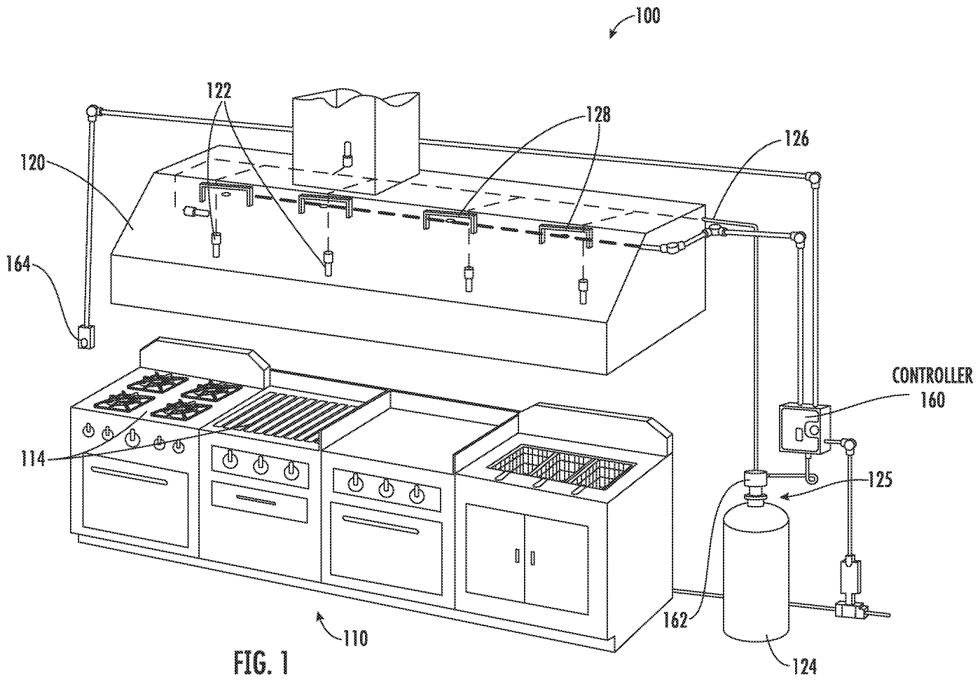

FIG. 1 is a schematic illustration of an exemplary fire suppression system 100. Fire suppression system 100 may be configured to deliver a fire suppression agent to one or more cooking appliances 110. In some embodiments, fire suppression system 100 may include a fire suppression agent source 124 (which may be viewed as one or more cylinders containing fire suppression agent), a control device 125 (also referred to as valve 125), spray nozzles 122, sensor(s) 128, and a controller 160 (and/or one or more additional/other components which are known to one of ordinary skill in the art). For example, fire suppression system 100 may further include other components that perform or assist in the performance of one or more processes that are consistent with disclosed embodiments.

In some embodiments, one or more components of fire suppression system 100 may be located separate or remotely from cooking appliance 110, such as within a vent hood 120, or alternatively, may be integrated or housed at least partially within a portion of the cooking appliance 110. It should be understood that the configuration of the fire suppression system 100 may vary based on the overall structural design of the cooking appliance 110. In some embodiments, fire suppression system 100 may include one or more of spray nozzles 122 associated with the cooking appliance 110 and a source of fire suppression agent 124 in the form of at least one self-contained pressurized cylinder. In embodiments including a plurality of cooking appliances 110, one or more spray nozzles 122 may be dedicated to each cooking appliance 110, or alternatively, one or more evenly spaced spray nozzles 122 may be used for all of the cooking appliances 110. It should be understood that the examples described may refer to a cooking appliance as the asset to be protected from fire. However, this is not intended to be limiting, the present control methods and systems may be used in protection of other assets.

In some embodiments, source of fire suppression agent 124 may be arranged in fluid communication with the nozzles 122 via an agent delivery path defined by a delivery piping system 126. In the event of a fire, the fire suppression agent may be configured to flow through the delivery piping system 126 to the one or more spray nozzles 122 for release directly onto an adjacent cooking hazard area 114 of the one or more cooking appliances 110. In operation, in some embodiments, in response to heat or flames exceeding an allowable limit, a controller 160 may be configured to direct a signal to an actuator 162 to open a control device 125 to allow the fire suppression agent to flow from the source 124 to the nozzles 122.

Those skilled in the art will readily appreciate that the fire suppression agent can be selected from materials such as water, dry chemical agent, wet chemical agent, or the like. Further, the source of fire suppression agent 124 may additionally contain a gas propellant for facilitating the movement of the fire suppression agent through the delivery piping system 126. However, embodiments where the propellant is stored separately from the fire suppression agent are also contemplated herein and are consistent with disclosed embodiments.

In some embodiments, fire suppression system 100 may be actuated in response to information from sensor(s) 128. For example, in some embodiments sensor(s) 128 may include a heat sensor including an activator bulb. When a fire is present, the increased heat resulting from the flames may cause the activator bulb to break, thereby releasing the tension on the cable connecting the fire sensing device to the controller 160. Alternatively, or in addition, the fire suppression system 100 may include a manual activation system 164, also referred to herein as a manual pull station, configured to actuate the controller 160 to activate the control device 125 to initiate operation of the fire suppression system 100.

FIG. 1 shows an example of a location for sensor(s) 128, however, one or more of the sensors may be placed in a plurality of locations within system 100 (e.g., at or near the suppressant source, spray nozzles, delivery piping, and/or at or near other components of system 100). In some embodiments, one or more of the sensors may be placed in the environment (e.g., general area) of the asset to be protected (in this example cooking appliance 110). For example, one or more of the sensors may be placed at, near or in the vicinity of cooking appliance 110, in the room/building where the cooking appliance is located, in other systems located in the same location as the cooking appliance, etc.

In some embodiments, sensor(s) 128 may be configured to generate output signals related to one or more control parameters. In some embodiments, the control parameters may indicate presence of fire/flames, likelihood/risk of fire ignition, and/or likelihood/risk of fire re-ignition. In some embodiments, the one or more control parameters may include fire conditions parameters, fire suppressant system parameters, and/or environmental parameters. For example, the fire conditions parameters may include one or more of flames, smoke, temperature, gas concentration, pressure, humidity, air flow, fluid levels, suppressant concentration, and/or other fire condition parameters indicating presence of fire/flames, likelihood/risk of fire ignition, and/or likelihood/risk of fire re-ignition.

In some embodiments, sensor(s) 128 may be configured to generate output signals related to fire suppressant parameters. For example, the one or more fire suppressant parameters may include one or more of a volume, pressure, flow rate, constitutions, concentration, temperature, and/or other parameters related to the fire suppression agent.

In some embodiments, sensor(s) 128 may be configured to generate output signals related to environmental parameters related to the environment of the asset to be protected. For example, the one or more environmental parameters may include one or more of air parameters (e.g., temperature, humidity, airflow, gas particles concentration, etc.), parameters related to presence of individuals in the area, parameters related to fire conditions outside of the asset to be protected (e.g., in the vicinity), parameters related to other systems (e.g., operating parameters, status, and/or conditions of other systems in the same location as the asset to be protected). It's to be noted, that one or more of the control parameters may be obtained from sources other than sensor(s) 128 as explained herein below.

In some embodiments, sensor(s) 128 may include one or more of smoke detectors, temperature sensors, flame detectors, gas particles detectors, pressure sensors, humidity sensors, air flow sensors, fluid sensors, position sensors, optical sensors, image sensors, timers, movement detectors, and/or other sensors for determining the one or more control parameters. In some embodiments, sensor information may be used to control one or more or operations of system 100 as described herein below. In some embodiments, controller 160 (described herein below) may be configured to provide some or all of the processing capabilities to one or more sensors 128.

In some embodiments, control device 125 may be operatively coupled with source 124, piping 126, sensor(s) 128, and/or controller 160. In some embodiments, control device 125 may be configured to control, direct, and/or regulate flow of the fire suppression agent. In some embodiments, control device 125 may be configured to control flow of the suppressant by opening, closing, and/or varying a size of flow passage. In some embodiments, control device 125 may be a control valve. For simplicity, this disclosure may refer to control device 125 as control valve or valve 125. However, any device capable of controlling, directing, and/or regulating flow of the fire suppression agent may be considered and is consistent with the present disclosure.

In some embodiments, control device 125 may include a positioner configured to move between degrees of opening to control flow of the suppressant. In some embodiments, the degrees of opening may vary within a range of fully opened and fully closed. Control device 125 may include one or more of a pneumatic, analog, and/or digital positioners. In some embodiments, control device 125 may include one or more of a sliding stem valve, a rotary valve, pinch valve, a diaphragm valve, and/or other flow control valves. In some embodiments, operations of control device 125 may be controlled by controller 160. For example, controller 160 may send control signals directly to control device 125, to an actuator of control device 125 (e.g., actuator 162), or to a controller for control device 125.

In some embodiments, controller 160 may be operatively coupled with valve 125 and sensor(s) 128. In some embodiments, controller 160 may be configured to determine one or more control parameters based on the output signals from sensor(s) 128. In some embodiments, the control parameters may indicate presence of fire/flames, likelihood/risk of fire ignition, and/or likelihood/risk of fire re-ignition. As described above, the control parameters may include one or more of fire conditions parameters, environmental parameters, time, fire suppressant parameters, and/or other parameters. In some embodiments, controller 160 may be configured to determine one or more of the control parameters based on information received from sources other than the sensor(s). For example, the control parameters may be pre-determined (e.g., by a user, a manufacturer, regulations, etc.), may be based on the type of asset to be protected, and/or may be based on historical data. For example, the historical data may be related to similar assets, fire conditions, environmental conditions, fire suppression systems, fire suppressant, and/or other similarities.

In some embodiments, controller 160 may include one or more processors configured to execute instructions stored on a memory to perform one or more operations of system 100 described herein. Other components known to one of ordinary skill in the art may be included in system 100 to gather, process, transmit, receive, acquire, and provide information used in conjunction with the disclosed embodiments. In addition, system 100 may further include other components that perform or assist in the performance of one or more processes that are consistent with disclosed embodiments.

In some embodiments, controller 160 may be configured to control operations of valve 125 based on the determined control parameters. For simplicity of description, the disclosure describes controlling flow of the fire suppressant by controlling the flow rate, however, this is not to be construed as limiting. The present control methods may be applied to other operations of valve 125. For example, controller 160 may control flow pressure of the fire suppressant, control degrees of openings of valve 125, and/or other control of operations of valve 125 based on the determined control parameters.

In some embodiments, controller 160 may be configured to activate valve 125 to discharge the suppression agent based on the determined control parameters. In some embodiments, controller 160 may activate valve 125 responsive to one or more of the control parameters reaching a parameter threshold (e.g., temperature threshold, smoke threshold, flame threshold, gas threshold, and/or other control parameter thresholds). In some embodiments, the first flow rate may be determined such that the fire/flames (and/or likelihood/risk of fire ignition, and/or likelihood/risk of fire re-ignition) are controlled (e.g., diminished, or removed). In these cases, controller 160 may determine the first flow rate based on the fire conditions. For example, an imminent risk of fire, or a large fire may require a high first flow rate (e.g., maximum flow rate) to control the fire conditions. In other cases, a low risk of fire, or a small fire may require a lower first flow rate (e.g., less than the maximum flow rate) to control the fire conditions.

In some embodiments, the first flow rate may be determined such that the detected fire conditions are controlled within a given amount of time (e.g., less than about 5 seconds, less than 10 seconds, etc.). In other words, controller 160 may determine the flow rate it takes to control the fire condition within a predetermined amount of time. The predetermined amount of time may be set by regulation, manufacturer, at installation, or by a user of system 100.

In some embodiments, controller 160 may be configured to stop, adjust flow, adjust fluid pressure, and/or control operations of valve 125 based on one or more control parameters. For example, in some embodiments, controller 160 may be configured to activate valve 125 to discharge the suppressant at a first flow rate based on one or more control parameters (e.g., heat and/or flame detection). In some embodiments, controller 160 may configured such that the first flow rate is a high flow rate (e.g., a maximum flow rate). In some embodiments, controller 160 may be configured to adjust (e.g., decrease) the initial flow rate subsequently based on the control parameters. Controller 160 may adjust the flow rate (up and/or down) based on a change in the control parameters (e.g., decrease or increase of a control parameter value). For example, in some embodiments, controller 160 may be configured to decrease and/or stop the flow rate once the fire/flames (and/or likelihood/risk of fire ignition, and/or likelihood/risk of fire re-ignition) are controlled, diminished, and/or removed. For example, the flow rate may be decreased in response to formation of a saponification layer, decrease in temperature, smoke, gas, flames, and/or changes in other parameters. Alternatively, the flow rate may be increased in response to lack of formation of a saponification layer, increase in temperature, smoke, gas, flames, and/or changes in other parameters. In some embodiments, the initial and/or the subsequent flow rates may be pre-determined (e.g., by regulation, requirements, user, etc.)

In some embodiments, controller 160 may be configured to adjust the initial rate based on time. For example, the suppression agent may be discharged at an initial flow rate for a pre-determined amount of time then adjust the flow to the second flow rate. In some embodiments, controller 160 may be configured to determine and/or adjust the amount of time based on the control parameters (described above). For example, the amount of time may be adjusted up or down based on presence of fire/flames, likelihood/risk of fire ignition, and/or likelihood/risk of fire re-ignition. For example, controller 160 may discharge the agent for a longer period of time in cases of large fires and shorter amounts of time in cases of small fires. Alternatively, a smaller fire may require a lower first flow rate (e.g., less than the maximum flow rate) to control the fire within less than about 5 seconds.

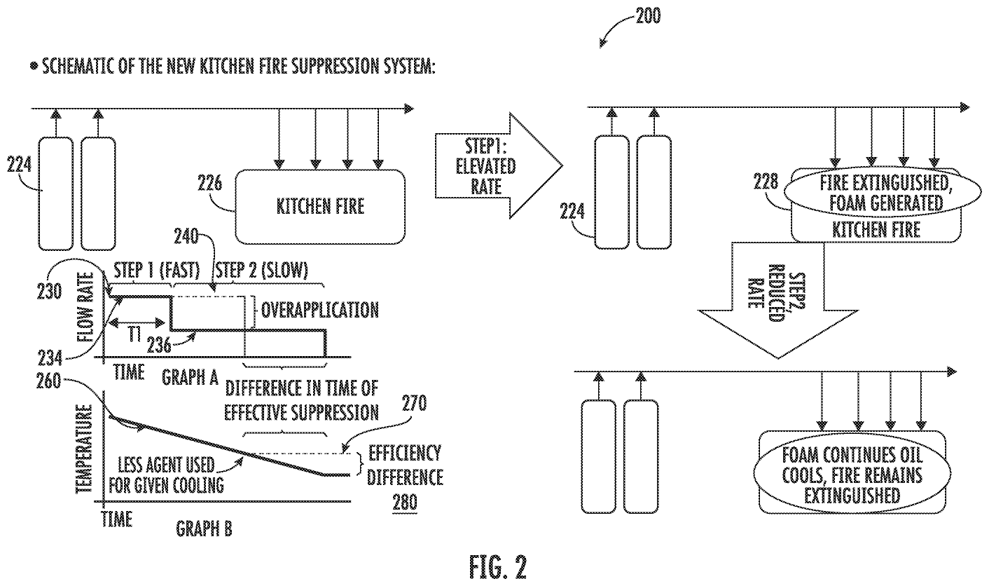

FIG. 2 shows an exemplary operation 200 of system 100. At Step 1, the suppression agent is released from source 224 to control kitchen fire 226 at first rate 234 to allow suppression agent to react with burning oil. At 228, in response to fire being extinguished, initiation of the saponification reaction, and/or the start of foam production, the controller is configured to adjust the flow rate at Step 2. In this case, the flow rate of the suppressant is reduced to a second flow rate 236.

Graph A shows an example of the suppressant flow rate over time. Graph A shows adjustment of flow rate 234 down to flow rate 236 after a period of time T1 according to embodiments of the present disclosure. As explained above, T1 may be determined based on the fire conditions (e.g., T1 may be the time it takes for fire being extinguished, initiation of the saponification reaction, and/or the start of foam production) or may be pre-determined (e.g., fixed regardless of the conditions). After T1, the flow rate is reduced to flow rate 236. Line 240 shows operations of traditional systems, where the agent is discharged at a constant high rate until it decreases because of the pressure decay in the cylinder. Adjusting the flow rate may prevent (or at least mitigate) overapplication of the agent. This may also help minimize time of effective suppression, minimize agent waste by reducing the potential of a high flow rate flooding and pushing the agent away before it can be used for further fire suppression and cooling.

Graph B shows oil temperature over time. As can be seen, the temperature of the oil diminishes as a result of the application of the agent. As depicted, adjusting the flow rate may be more effective at lowering the oil temperature when compared with traditional fire suppression systems (see line 270, which illustrates oil temperature over time with a traditional fire suppression system, emphasized by efficiency difference 280).

In some embodiments, Step 1 and Step 2 may be alternated as needed. For example, the controller may be configured to increase the flow rate (up from the second flow rate to the first flow rate or to a different flow rate). For example, controller 160 may increase the flow rate based on sensor information (e.g., based on a status of one or more or of the flames, fire, smoke, foam formation, temperature, etc.), environmental information, time, preprogramming, etc. In some embodiments, controller 160 may increase the flow rate (from the second flow rate) in response to re-ignition, saponification/foam not reaching a predetermined level, and/or in response to one or more parameters not reaching a threshold parameter (e.g., temperature, flame, smoke, gas, etc.).

Returning to FIG. 1, in some embodiments, controller 160 may be configured to control valve 125 to discharge the agent intermittently. In some embodiments, valve 125 may be configured to discharge the agent at a high initial flow rate/pressure for a period of time (discharge period) and then stop the discharge completely (shut off period). The initial discharge (which may provide a high amount of agent at a high pressure) may help a foam layer build up over cooking appliance 110. Stopping the discharge completely after the initial discharge may prevent (or at least mitigate) the foam layer from spilling over and/or overflowing of the agent off of the foam layer without reaching the hot oil. In some embodiments, the initial shut off period may be the same as the initial discharge period or may be different than the initial discharge period (e.g., longer, or shorter).

In some embodiments, valve 125 may be configured to discharge subsequent flows of the agent at subsequent flow rate/pressure levels for subsequent discharge periods and stop the discharge completely for subsequent shut off periods. For example, in some embodiments, valve 125 may be configured to discharge a second flow of the agent at a second flow rate/pressure level for a second discharge period, then stop the discharge completely for a second shut off period. In some embodiments, the second flow of the agent may be discharged at the same flow rate as the first flow rate or may be different than the first flow rate (e.g., lower, or higher). In some embodiments, the second shut off period may be the same as the initial shut off period or may be different than the initial shut off period (e.g., longer, or shorter). The discharge/shut off cycles may be repeated until the fire conditions are controlled and/or the agent is dispensed (e.g., complete cylinder release).

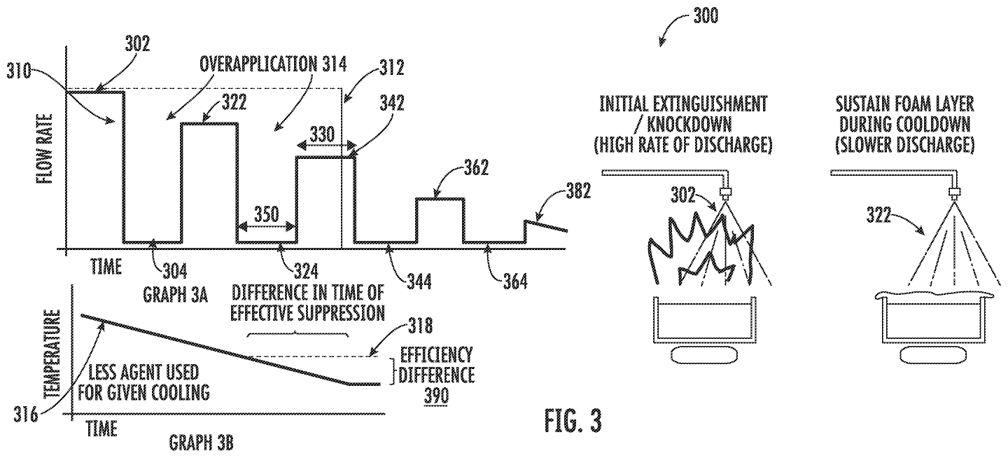

FIG. 3 shows another exemplary operation 300 of system 100. Graph 3A shows an example 310 of fire suppressant flow rate over time. The fire suppression agent is discharged intermittently. Controller 160 (shown in FIG. 1) may be configured to turn valve 125 (shown in FIG. 1) ON and/or OFF alternatively over time. For example, valve 125 may be configured to discharge the suppressant (device 125 is ON) at a first flow rate 302, stop the discharge 304 (device 125 is OFF), then discharge the suppressant at a subsequent flow rate 322, and stop the discharge 324. This may be repeated until the fire conditions are controlled and/or the agent is dispensed (e.g., complete cylinder release). This is shown in cycles (342, 344), (362, 364), (382), etc. In some embodiments, first flow rate 302 may be the maximum flow rate. Subsequent flow rates (322, 342, 362, 382, etc.) may decrease in value over time (e.g., until complete release of the agent). In this example, the agent is dispensed at the different flow rates for relatively the same discharge period of time 330 and stopped for relatively the same shut off time 350. In some embodiments, the discharge period of time 330 may be equal to shut off period 350.

Line 312 shows operations of traditional systems, where the agent is discharged at a constant high rate until it decreases because of the pressure decay in the cylinder. Adjusting the flow rate may prevent (or at least mitigate) overapplication of the agent (shown by regions 314). Graph 3B shows oil temperature over time. As can be seen the temperature of the oil diminishes as a result of the application of the agent. As depicted, adjusting the flow rate may be more effective at lowering the oil temperature when compared with traditional fire suppression systems (see line 318, which illustrates oil temperature over time with a traditional fire suppression system, emphasized by efficiency difference 390.

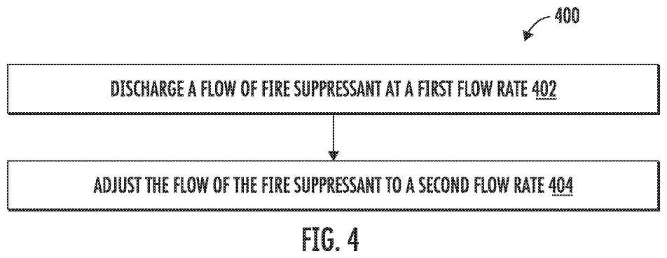

FIG. 4 is a flow diagram illustrating an exemplary method 400 for controlling operations of fire suppression system. The operations of method 400 presented below are intended to be illustrative. In some implementations, method 400 may be accomplished with one or more additional operations not described and/or without one or more of the operations discussed. Additionally, the order in which the operations of method 400 are illustrated in FIG. 4 and described below is not intended to be limiting.

At an operation 402 of method 400, a flow of fire suppressant is discharged at a first flow rate (e.g., as described above). In some embodiments, operation 402 may be performed by a controller the same as or similar to controller 160 (shown in FIG. 1 and described herein).

At an operation 404 of method 400, the flow of fire suppressant is adjusted to a second flow rate during the discharge (e.g., as described above). In some embodiments, operation 404 may be performed by a controller the same as or similar to controller 160 (shown in FIG. 1 and described herein).

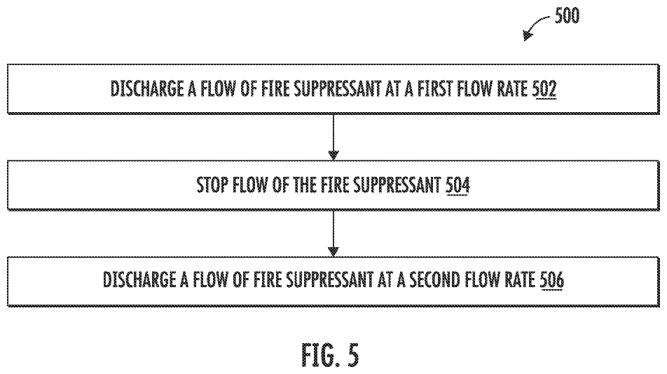

FIG. 5 is a flow diagram illustrating an exemplary method 500 for controlling operations of fire suppression system. The operations of method 500 presented below are intended to be illustrative. In some implementations, method 500 may be accomplished with one or more additional operations not described and/or without one or more of the operations discussed. Additionally, the order in which the operations of method 500 are illustrated in FIG. 5 and described below is not intended to be limiting.

At an operation 502 of method 500, a flow of fire suppressant is discharged at a first flow rate (e.g., as described above). In some embodiments, operation 502 may be performed by a controller the same as or similar to controller 160 (shown in FIG. 1 and described herein).

At an operation 504 of method 500, the flow of fire suppressant is stopped (e.g., for a period of time, as described above). In some embodiments, operation 504 may be performed by a controller the same as or similar to controller 160 (shown in FIG. 1 and described herein).

At an operation 506 of method 500, a second flow of fire suppressant is discharged at second first flow rate (e.g., as described above). In some embodiments, operation 506 may be performed by a controller the same as or similar to controller 160 (shown in FIG. 1 and described herein).

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every.

What is claimed is:

1. A fire suppression system comprising:
a control valve operatively coupled with a cylinder containing a fire suppressant; and
a controller operatively coupled with the control valve, wherein the controller is configured to:
command the control valve to open, discharging a flow of the fire suppressant at a first flow rate; and
adjust the flow of the fire suppressant to a second flow rate during the discharge.

2. The fire suppression system of claim 1, wherein the second flow rate is lower than the first flow rate.

3. The fire suppression system of claim 1, further comprising:
one or more sensors configured to generate output signals conveying information related to fire conditions; and wherein
the controller is configured to:
determine one or more control parameters based on the output signals; and
adjust the first flow rate based on the one or more control parameters.

4. The fire suppression system of claim 3, wherein the controller is configured to
adjust the first flow rate based on one or more of the control parameters reaching a parameter threshold.

5. The fire suppression system of claim 1, wherein the controller is configured to:
adjust the second flow rate to a subsequent flow rate.

6. The fire suppression system of claim 5, wherein the subsequent flow rate is lower than the second flow rate.

7. The fire suppression system of claim 5, wherein the subsequent flow rate is higher than the second flow rate.

8. The fire suppression system of claim 1, wherein the second flow rate is different than a flow rate resulting from a decay in pressure in the fire suppressant source.

9. A method for controlling delivery of fire suppressant, the fire suppression system comprising a control valve, a fire suppressant source, and a controller, the method comprising:
discharging a flow of the fire suppressant at a first flow rate; and
adjusting the flow of the fire suppressant to a second flow rate during the discharge.

10. The method of claim 9, wherein the second flow rate is lower than the first flow rate.

11. The method of claim 9, further comprising:
determining one or more control parameters based on the output signals from one or more sensors; and
adjusting the first flow rate based on the one or more control parameters.

12. The method of claim 11, wherein the first flow rate is adjusted based on one or more of the control parameters reaching a parameter threshold.

13. The method of claim 9, further comprising:
adjusting the second flow rate to a subsequent flow rate.

14. A fire suppression system comprising:
a control valve operatively coupled with a cylinder containing a fire suppressant; and
a controller operatively coupled with the control valve, wherein the controller is configured to:
command the control valve to open and close, discharging the fire suppressant intermittently, the control valve being commanded to:
discharge a flow of the fire suppressant at a first flow rate;
stop the discharge; and
discharge a second flow of the fire suppressant at a second flow rate.

15. The fire suppression system of claim 14, wherein the control valve is commanded to:
discharge the fire suppressant at the first flow rate for a first discharge period of time; and
stop the discharge for a first shut-off period of time.

16. The fire suppression system of claim 14, wherein:
the controller is configured to determine the first discharge and/or the first shut off period of time.

17. The fire suppression system of claim 14, wherein:
the control valve is configured to stop the discharge after a second discharge period of the second flow.

18. The fire suppression system of claim 15, further comprising:
one or more sensors configured to generate output signals conveying information related to fire conditions; and
the controller is configured to:
determine one or more control parameters based on the output signals; and
determine the first discharge and/or the first shut off period of time based on the control parameters.

19. The fire suppression system of claim 18, wherein the controller is configured to:
determine the first flow rate based on the determined control parameters.

20. The fire suppression system of claim 18, wherein:
the controller is configured to determine the second flow rate based on the determined control parameters reaching a parameter threshold.
